(19) United States
(12) Patent Application Publication
(10) Pub. No.: US 2023/0113876 A1
(43) Pub. Date: Apr. 13, 2023

(54) MULTI-MATERIAL SEGMENTED STATOR

(71) Applicant: CRS HOLDINGS, LLC, Wilmington, DE (US)

(72) Inventors: NATAN ARONHIME, Bala Cynwyd, PA (US); JAYDIP DAS, Santa Clara, CA (US); MINGDA LIU, Mountain View, CA (US); MD MEHEDI, Wynnewood, PA (US); BRANDON TROUP, Birdsboro, PA (US)

(21) Appl. No.: 17/937,867

(22) Filed: Oct. 4, 2022

Related U.S. Application Data
(60) Provisional application No. 63/253,731, filed on Oct. 8, 2021.

(51) Int. Cl. H02K 1/14; H02K 1/16; H02K 1/02

(52) U.S. Cl. CPC H02K 1/148; H02K 1/02; H02K 1/165; H02K 2213/03

(57) ABSTRACT

A stator for a rotating machine with tooth segments and adjoining yoke segments, in which the tooth segments may include a higher saturation induction material and the yoke segments may include a lower saturation induction material, the stator optionally provided as a stack of single-material and multi-material lamination layers.

### CROSS REFERENCE TO RELATED APPLICATION

This application claims the benefit of Provisional Patent Application No. 63/253,731, filed Oct. 8, 2021, the entirety of which is incorporated herein by reference.

### FIELD OF THE INVENTION

The present invention relates generally to stators for rotating machines.

### BACKGROUND OF THE INVENTION

The known stators for rotating electric machines are typically made from stacked laminations of a soft magnetic material. The stator can be roughly divided into two areas: a yoke that is ring-shaped and a plurality of teeth that extend radially from the yoke. It has been recognized that for different types of rotating electric machines, the teeth and the yoke experience different magnetic flux densities when the electric machine is operating. More specifically, the teeth are usually subject to significantly higher magnetic flux densities than the yoke portion. Because of that phenomena, it has been proposed to make such components from different magnetic materials in order to improve the efficiency and cost effectiveness of a rotating electric machine.

Although the multi-material concept is recognized, the art has not provided a viable method of making such components. Nor has the art recognized any physical limitations on the geometry of such components in order for the use of multiple soft magnetic materials to be effective for performance and economical for worthwhile cost benefit, compared to the standard soft magnetic materials currently in use.

### SUMMARY OF THE INVENTION

In accordance with one aspect of the present invention, a stator assembly may be provided having a cylindrical shape with a longitudinal axis extending therethrough and a circular cross-section in a plane perpendicular to the longitudinal axis. The stator assembly may include a plurality of tooth segments extending along a radial direction of the circular cross-section, with the plurality of tooth segments each having a thickness, t, measured perpendicular to the radial direction and having a yoke-segment depth, d1, measured along the radial direction. The stator assembly may also include a plurality of yoke ring segments adjacent to and surrounding the tooth segments at the yoke-segment; the plurality of yoke ring segments may have a depth, d, measured along the radial direction, with the distance d including the yoke-segment depth, d1. The ratio of d to t may be greater than 1:2. The tooth segments may be formed of a soft magnetic alloy having a high saturation induction, and the yoke ring segments may be formed of a soft magnetic alloy having a lower saturation induction than the tooth segments. The stator assembly may have a ratio of d to t between 1:2 and 2:1, and/or the ratio of d1 to t may be between 0 and 1:2. Alternatively, the ratio of d1 to t may be between 1:2 and 2:1. In addition, the ratio of d to t may be greater than 2:1 and/or the ratio of d1 to t may be between 0 and 1:4, or between 1:4 and 3:1. Further, the plurality of tooth segments may each include a plurality of stress points at a location of contact between the plurality of tooth segments and the plurality of yoke ring segments.

In another of its aspects the present invention may provide a stator assembly comprising a plurality of tooth segments extending along a radial direction of the stator assembly, and a plurality of yoke ring segments adjacent to and surrounding the tooth segments, wherein the plurality of tooth segments each comprises a plurality of stress points at a location of contact between the tooth segments and the yoke ring segments.

Still further, in another of its aspects the present invention may provide, a stator stack assembly for a rotating machine, comprising in order from a first end of the stack to an opposing second end (to provide the stack): a first end single-material lamination layer, a plurality of multi-material lamination layers, and a second end single-material lamination layer. A plurality of pins may extend through the stack. The plurality of multi-material lamination layers may include a plurality of stator tooth segments and a plurality of stator yoke segments adjoining the stator tooth segments. An adhesive material may be provided to bond i) the plurality of multi-material lamination layers including the stator tooth segments together and/or ii) to bond the plurality of multi-material lamination layers including the stator yoke segments together. The stator stack assembly may include a tab in a selected first layer of the plurality of multi-material lamination layers and a complementary detent in a selected second layer of the plurality of multi-material lamination layers, with the detent adjacent to and in registry with the at least one tab. The selected first layer may include the stator tooth segments or may include the stator yoke segments. The stator tooth segments may be formed of a soft magnetic alloy having a high saturation induction, and the stator yoke segments may be formed of a soft magnetic alloy having a lower saturation induction than the stator tooth segments.

In yet another of its aspects the present invention may provide a method of making a stator for a rotating electrical machine that includes the following steps:
a. Stamping or cutting laminations for the tooth segments of the stator from high saturation induction sheet/strip material;
b. Stamping or cutting laminations for the yoke segment(s) from low saturation induction sheet/strip material;
c. Stacking the tooth segment laminations to form a tooth segment stack;
d. Heat treating the tooth segment stack to obtain a desired combination of magnetic and mechanical properties;
e. Stacking the yoke segment laminations to form a yoke segment stack;
f. Bonding the tooth segment laminations together with an adhesive material and curing the adhesive material;
g. Bonding the yoke ring segment laminations together with an adhesive material and curing the adhesive material;
h. Assembling and bonding the tooth segment stack to the yoke segment stack with the adhesive material to form the stator, and then
i. Heat treating the assembled stator to cure the adhesive material.
In step a., the high saturation induction material may be coated with an insulation layer or may be uncoated. In step d., the high saturation induction material may be heat treated either as strips or in the stacked condition.

In accordance with a second aspect of the present invention, there is provided a second method of making a stator for a rotating electrical machine that includes the following steps.
a. Stamping or cutting laminations for the stator, including the tooth and yoke portions, from high saturation induction sheet/strip material;
b. Stamping or cutting laminations for the stator from low saturation induction stator sheet/strip material;
c. Interlocking the high saturation induction and low saturation induction teeth and yoke portions into desired stack shape;
d. Heat treating the assembled laminations to obtain a desired combination of magnetic and mechanical properties.

In accordance with a further aspect of this invention there is provided a stator for a rotating electrical machine comprising a ring-shaped yoke and a plurality of teeth extending radially from the yoke, wherein the width of a tooth (t) and the annular width (d) of the ring-shaped yoke are related such that t is less than d (t < d), and up to 75 volume percent, preferably 20-75 volume percent, of the stator material is a high saturation induction material and the remainder of the stator material is a soft magnetic material such as a silicon steel or other soft magnetic alloy having a saturation induction that is lower than the saturation induction of the tooth material. Each lamination thickness of high induction material in the tooth can range from 0.05 mm to 0.5 mm, while the yoke material lamination thickness can range from 0.05 mm to 0.5 mm.

In a further embodiment of this aspect of the invention, the stator may comprise a ring-shaped segment and a plurality of tooth segments extending radially from the ring-shaped segment. The tooth segments may comprise an entire tooth, a portion of a tooth, or a tooth and a portion of the yoke.

Here and throughout this application the term “high saturation induction” means a saturation magnetic induction (Bsat) of about 2 to 2.4 tesla (T) which may be provided by using an iron-cobalt alloy. The term “low saturation induction material” means a material characterized by having a saturation magnetic induction of about 1.7 to 2.1 tesla (T) which may be provided by using a 2 to 4 wt. % silicon containing steel or an iron-cobalt alloy material.

### BRIEF DESCRIPTION OF THE DRAWINGS

The foregoing summary and the following detailed description of exemplary embodiments of the present invention may be further understood when read in conjunction with the appended drawings, in which:

FIG. 1 schematically illustrates a plan view of a single lamination for a stator stack having a known geometry;

FIG. 2 schematically illustrates a plan view of a segmented lamination for a stator stack having a second known geometry;

FIG. 3 schematically illustrates a segmented lamination for a stator stack made in accordance with a first embodiment of the present invention;

FIG. 4 illustrates exemplary motor responses for 6-segment designs the type shown in FIG. 3, with various single material and multi-material designs;

FIG. 5 illustrates a model used to simulate Si-steel (M19) and Hiperco®50 multi-material structures, where the model provides a representation of the effective magnetic flux flow in the multi-materials stack in accordance with the present invention, such ones of the type shown in FIG. 3, for example;

FIG. 6 illustrates the various scenarios used in the model of FIG. 5;

FIGS. 7-9 illustrate magnetic responses of a multi-materials structure with a ratio for back-iron: tooth of 2.5:1;

FIGS. 10-12 illustrate magnetic responses of a multi-materials structure with a ratio of back-iron: tooth of 1.25:1;

FIGS. 13-15 illustrate magnetic responses of a multi-materials structure with a ratio of back-iron: tooth of 1:2, showing that the magnetic properties are affected significantly for this structure;

FIGS. 16-17 schematically illustrate exemplary configuration of the back-iron and tooth in accordance with the present invention;

FIGS. 18-20 schematically illustrates an exemplary configuration of a multi-material stator in accordance with the present invention having a fir type connection design;

FIG. 21 illustrates a simulation of the Von Mises stress distribution contour in stator core at passive (left) and loaded (right) condition structures of FIGS. 26-28;

FIGS. 22A-22C schematically illustrate an exemplary configuration of a pin assembly for a multi-material connection in accordance with the present invention, with FIG. 22A showing a drone motor stator stack, FIG. 22B showing an EV motor stator stack, and FIG. 22C showing a segmented EV motor stator stack; and

FIGS. 23-26 schematically illustrate exemplary configurations of stack assemblies in accordance with the present invention.

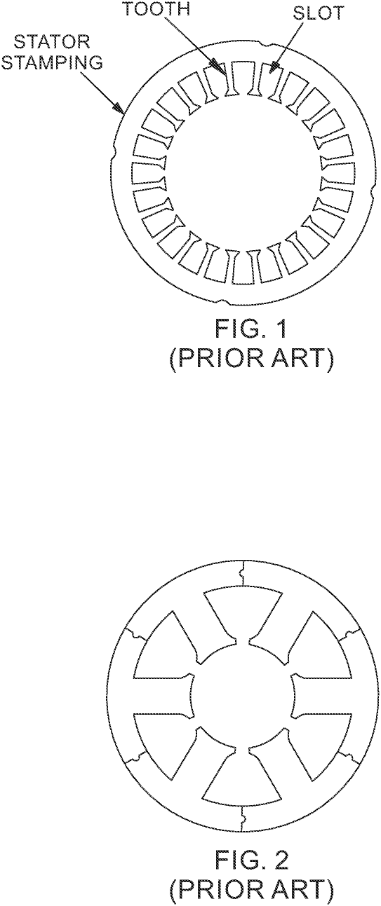

### DETAILED DESCRIPTION OF THE INVENTION

In one of its aspects a process according to the present invention may be directed to improving the operating performance of a rotating electrical machine such as an electric motor or generator by utilizing two different soft magnetic materials to make the stator portion of the electrical machine. In connection with this aspect of the invention the steps that constitute the process may be selected based on the geometry of the stator.

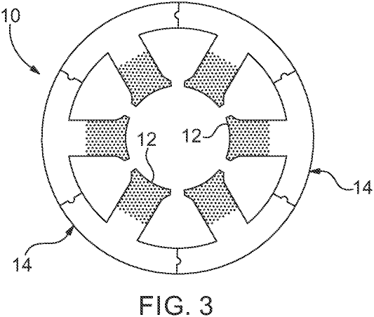

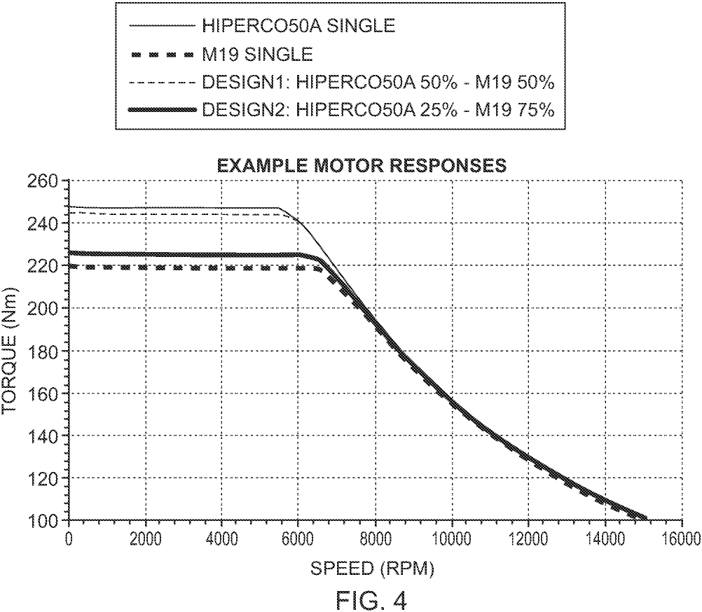

Referring now to the figures, wherein like elements are numbered alike throughout, and in particular FIG. 3, a stator 10 contains a tooth 12 and a back-iron (yoke) section 14. Several yoke sections 14 can be joined to form the stator 10. Alternatively, the stator 10 may consist of a solitary yoke section (not shown). The tooth 12 may be positioned midway on the yoke section 14, as shown in FIG. 3 or one or more teeth 12 can be positioned anywhere on the yoke 14, depending on a required configuration.

The tooth 12 may be preferably made from a soft magnetic alloy that may be characterized by a high saturation induction (Bₛₐₜ) of about 2-2.4 tesla (T). Examples of suitable magnetic alloys may include some combinations of Carbon, Nickel, Manganese, Silicon, Cobalt, Vanadium, Chromium, Copper, aluminum, and Iron. Commercially available magnetic alloys include CARTECH® HIPERCO® 50A alloy, CARTECH® HIPERCO® 50 alloy, CARTECH® HIPERCO® 27 alloy, and CARTECH® HYPOCORE® alloy (Carpenter Technology Corporation, USA). The yoke section 14 can be made from a magnetic alloy characterized by having a saturation magnetic induction of about 1.7 to 2.1 tesla (T). Suitable materials for the yoke section 14 include silicon irons such as M19.

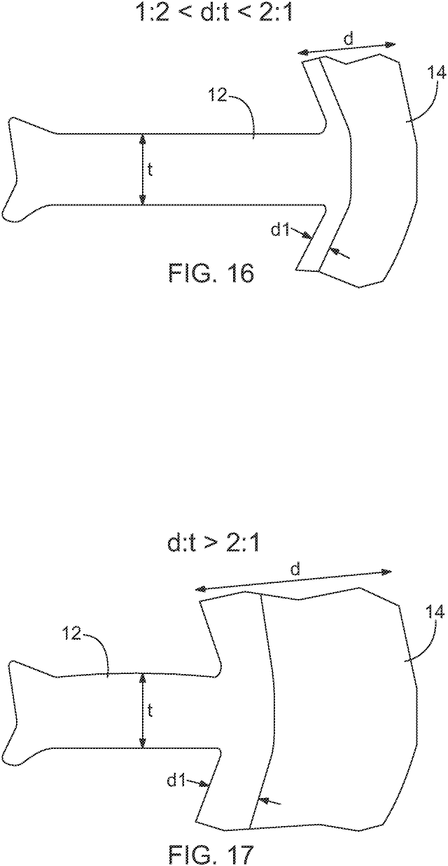

In an embodiment, the tooth 12 of the assembled stator 10 may constitute at least about 20% of the volume of the stator 10. In such an embodiment, the high saturation induction magnetic alloy is used only in the tooth 12 of the stator 10, whereas the yoke section 14 may include the silicon irons such as M19. In other embodiments, the tooth 12 may constitute 30% or more of the volume of the stator, for example, up to 75%. In the latter arrangement, the tooth 12 may include portions of the yoke section 14. In other words, the high saturation induction magnetic alloy will be replacing the silicon iron material proximate the tooth 12 as shown in FIG. 16.

In an embodiment, a stator 10 of the present invention may preferably be made in accordance with the following process steps. In a first step, laminations for the tooth 12 segments are stamped or cut from sheet or strip forms of the soft magnetic alloy having a high saturation induction. The laminations can be insulation coated or uncoated. Next, laminations for the yoke section 14 are stamped or cut from sheet/strip material having lower saturation induction. The yoke section 14 laminations may be formed as full rings or as segments. The yoke section 14 laminations are then stacked to form a yoke portion. The yoke portion containing the stacked yoke section 14 laminations may be formed as a ring segment, as shown in FIG. 3.

The tooth 12 segment laminations are stacked to form a tooth portion and then heat treated to obtain a desired combination of a magnetic property and a mechanical property. Further, the heat treated laminations can be insulation coated to improve the core loss responses of the stack. The tooth 12 segment laminations may be bonded together with an adhesive material, such as epoxy, which is then cured in a prescribed manner for the adhesive material. For example, curing some adhesives can be accomplished with heating a device to be cured in a heater or exposing the adhesive to a certain wavelength of light.

Remisol EB-548 (Rembrandtin, Vienna Floridsdorf, Austria) is an example of adhesive for bonding stack laminations used in stators. The choice of adhesive and/or bonding material is based upon many factors, including at least its adhesion strength, thermal stability, water and chemical resistance, electrical insulation properties, magnetic properties, vibration control, and impact resistance. The yoke portion laminations may be bonded together with a suitable adhesive material, such as epoxy. In an alternative arrangement, the yoke portion laminations can be interlocked. The tooth segments and the yoke segment or segments are assembled and can be bonded, press fitted, riveted, or interlocked together.

The inventors have further recognized that the geometry of the stator is an important factor to understand if a specific design is suitable for multi-materials. In particular, the inventors have concluded that the back-iron should be wide enough, to accommodate the advantages that can be obtained from the multi-materials design, and have discovered that the high saturation induction material volume in the back-iron also controls the optimum performance of the multi-material based stator design of the present invention.

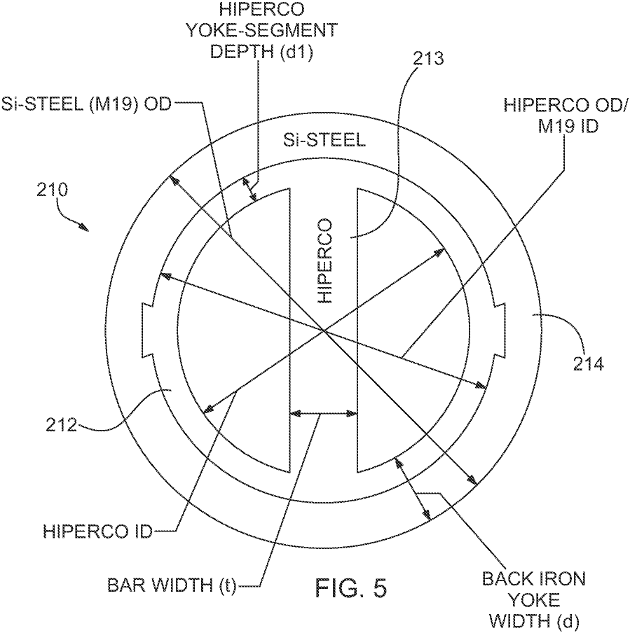

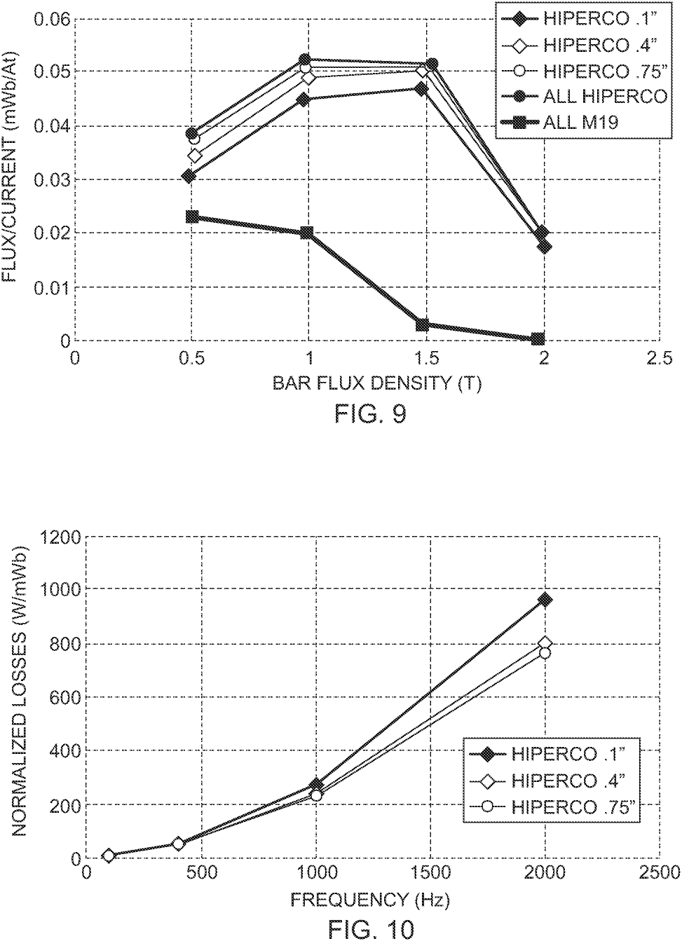

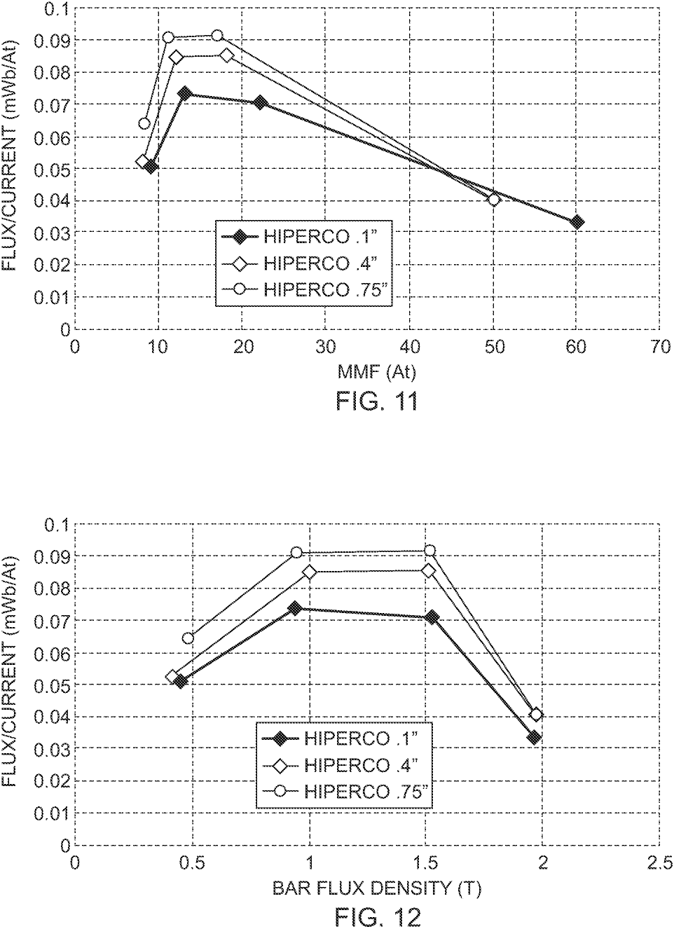

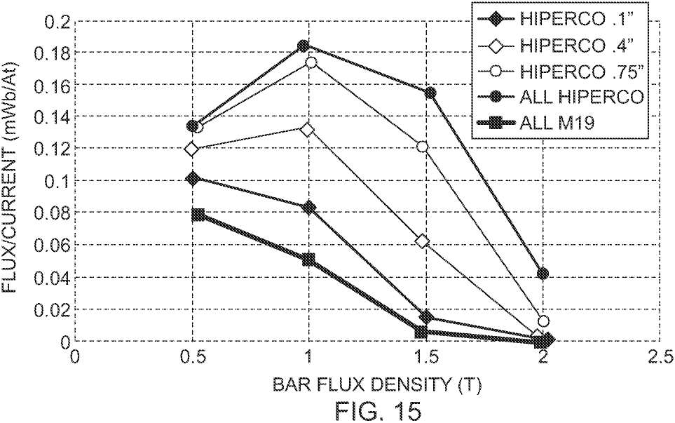

For example, further to the design considerations introduced above, the inventors have created additional structural configurations and specific parameters therefore through computer simulation research, FIGS. 5-15. In order to understand the design rules for a multi-material stator, simulations were performed with a custom design. FIG. 5 shows a simulation design 210 with a Si-steel (M19) and Hiperco®50 multi-material structure, that represents the effective magnetic flux flow in the multi-material stack in a rotor, such as that shown in FIG. 3. In the simulation design 210 the “Si-Steel” back-iron yoke 214 represents the back-iron or part of the yoke 14 and the Hiperco®50 ring 212 and bar 213 represent contributions of the teeth 12 and part of the yoke 14 to the magnetic flux flow.

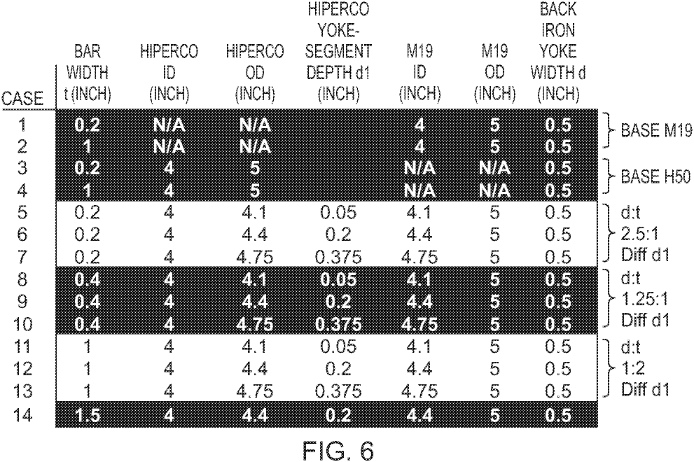

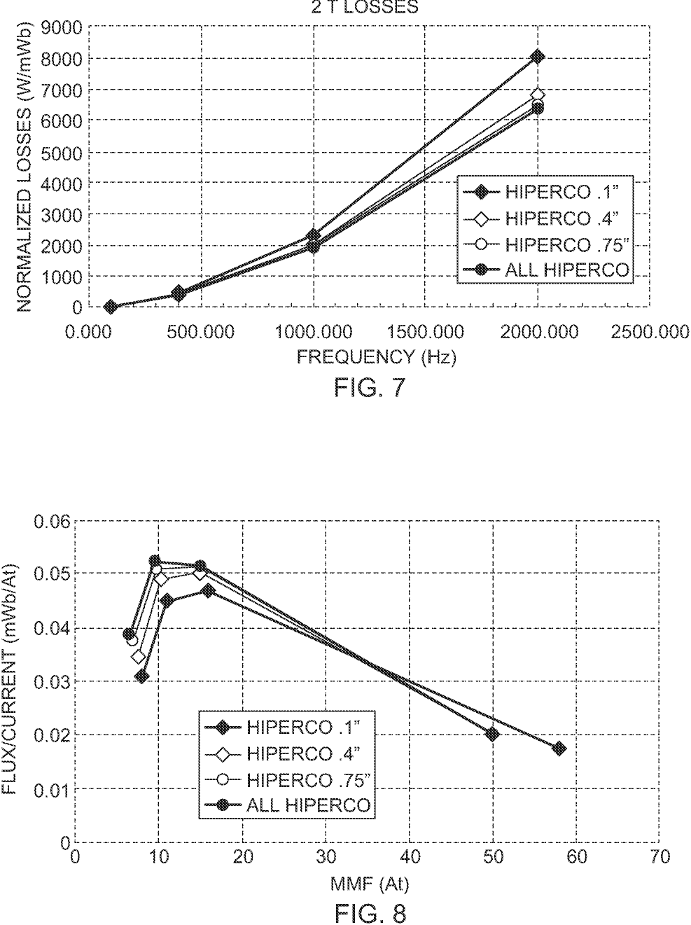

The width of the bar 213 along with the outer diameter (OD) and inner diameter (ID) of both the ring 212 and back-iron yoke 214 were varied for respective materials as listed in the table of FIG. 6 to see the effect on the magnetic responses of the structure 210. FIGS. 7-15 show exemplary simulation results. For FIGS. 7-9, the simulation used a bar/tooth width t = 0.2ʺ, back iron yoke width d = 0.5ʺ for a d:t ratio = 2.5:1. One can see that the losses for a diameter width of 0.1ʺ Hiperco®50 back-iron were ~25% higher than all Hiperco®50. It should be noted that the Hiperco®50 diameter width is defined as twice of the Hiperco®50 yoke segment depth d1 and indicates the Hiperco®50region extending into the back iron portion. Also, for 0.4ʺ and 0.75ʺ diameter width H50 back-iron were close to an all Hiperco®50 back-iron configuration. A 0.1ʺ diameter width Hiperco®50 back-iron also produced ∼ 8-15% less flux/current at 1.5-2 T induction, and 0.4ʺ and 0.75ʺ diameter width Hiperco®50 back-iron were close to an all Hiperco®50 back-iron configuration. A 0.1ʺ diameter width Hiperco®50 back-iron required 20% greater MMF to reach 2 T induction. Thus, one can see that for thicker back-iron 214 with a back-iron : tooth ratio greater than 2:1 (FIGS. 7-9), the losses and flux density were not impacted significantly for a multi-materials structure vs a single material Hiperco®50 irrespective of the presence of Hiperco®50 in the region of the back-iron.

As one moves towards a lower back-iron: tooth ratio, for example, towards 1.25:1 (FIGS. 10-12), the Hiperco®50 back-iron region becomes important. FIGS. 10-12 use a bar/tooth width t = 0.4ʺ, back-iron yoke width d= 0.5ʺ for a d:t ratio of 1.25:1. From FIGS. 10-12 we conclude that:
losses for 0.1ʺ diameter width Hiperco®50 back-iron were ~25% higher than 0.75ʺ diameter with Hiperco®50, and 0.4ʺ and 0.75ʺ diameter width Hiperco®50 back-iron dimensions were close to each other;
a 0.1ʺdiameter width Hiperco®50 back-iron also produced ∼ 20-30% less flux/current at 1.5-2 T induction vs. 0.75ʺ diameter width Hiperco®50.
a 0.4ʺ diameter width Hiperco®50back-iron thickness was close to 0.75ʺ diameter width Hiperco®50 thickness;
a 0.1ʺ diameter width Hiperco®50back-iron required 20% greater MMF to reach 2 T induction;
a Hiperco®50 back-iron: tooth ratio of 1:8 would yield about 20-30% lower performance; and
Hiperco®50 back iron: tooth ratio of 1:2 may yield nearly 7-10% lower performance.
Thus, a thicker back-iron with the Hiperco®50 portion offers better responses.

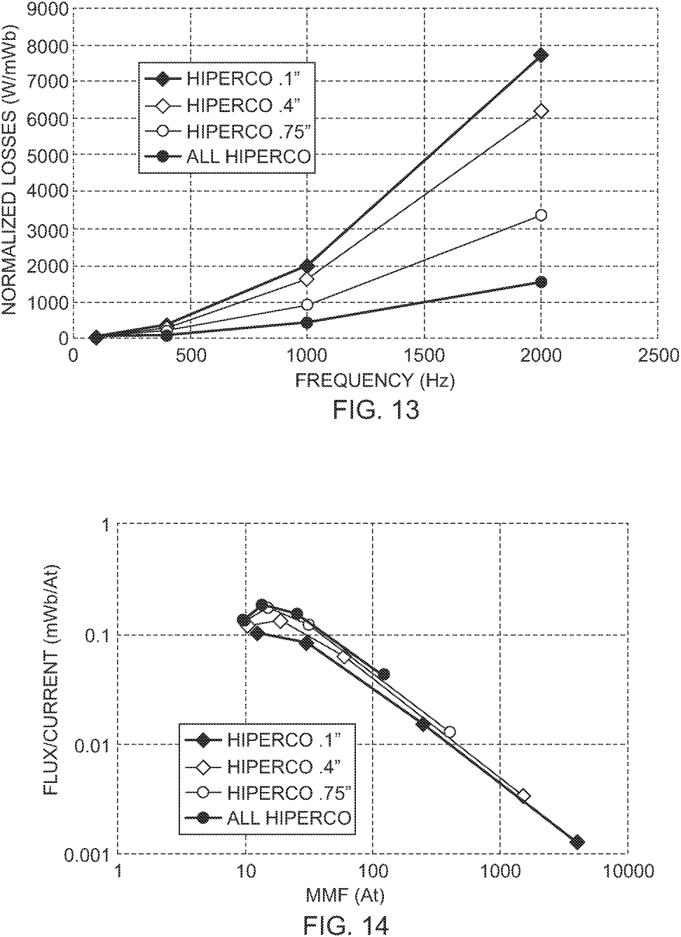

As one moves further towards a smaller back-iron: tooth ratio, for example, 1:2 (FIGS. 13-15), the losses and flux densities were affected significantly and the multi-materials structure may not offer any performance benefit. FIGS. 13-15 use a bar/tooth width t= 1″, back-iron yoke width d= 0.5ʺ d:t = 1:2. From FIGS. 13-15 we observe that: losses for 0.1ʺ diameter width Hiperco®50 back-iron were ~5× higher than an all Hiperco®50 back-iron configuration; a 0.4″(4×) and 0. 75″ (2×) diameter width Hiperco®50 back-iron were also pretty high; a 0.1ʺ diameter width Hiperco®50 back-iron also produced ~8-15× less flux/current at 1.5-2 T induction vs an all Hiperco®50 back-iron configuration; and 0.4ʺ and 0.75ʺ diameter width Hiperco®50 back-iron designs sit in between. A summary of our conclusions is provided in Table 1.

TABLE 1

| | | | |
|---|---|---|---|
| | Back-iron : tooth | H50 back-iron : tooth | Multi-material core performance compared to Hiperco®50 core |
| Multi-material does not work | d:t < 1:2 | all | |
| Multi-material works with certain performance benefit over Si-steel | 1:2 < d:t < 2:1 See FIG. 16 | 0< d1:t< 1:2 | 10% - 30% lower performance |
| | | 1:2 ≤dl:t < 2:1 | 2% - 10% lower performance |
| | d:t > 2:1 See FIG. 17 | 0< d1:t< 1:4 | 5% - 20% lower performance |
| | | 1:4 < d1:t < 3:1 | 0% - 5% lower performance |

Table 1 and FIGS. 16, 17 provide design guidance and demonstrate where multi-materials can be beneficial. It should be noted that the design rules would be applicable for segmented and non-segmented stator stacks each segment involving one or multiple teeth or the whole stator structure with soft magnetic materials.

As seen in Table 1, the yoke width (d) should be similar or greater than the teeth width (t) to get the maximum benefit from multi-materials structure, and the teeth indentation male part (yoke-segment depth d1) should be close to 1:1 to the teeth width (t) to get the same level performance to Hiperco®50, FIGS. 16-17. “Fir” type connection design with interference fit (assembly idea)

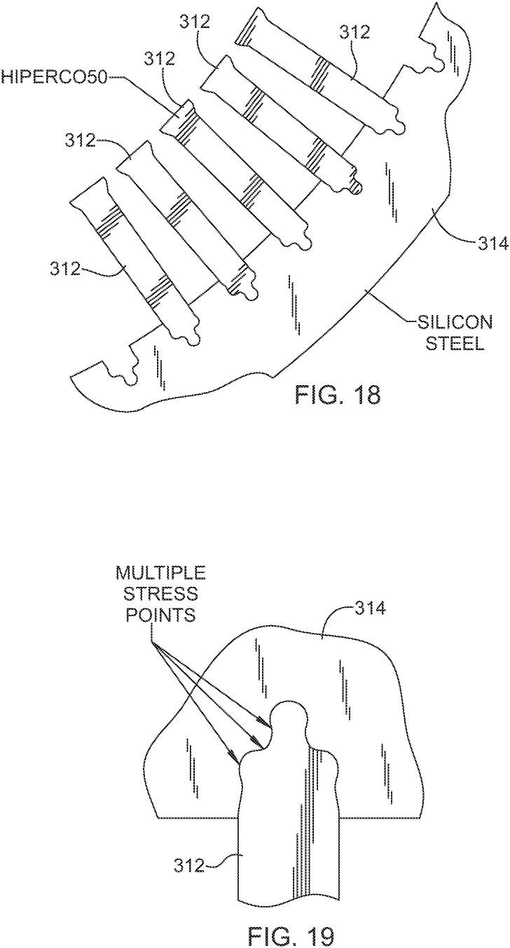

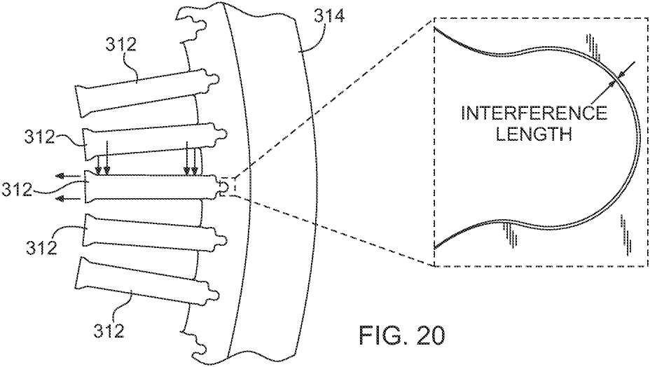

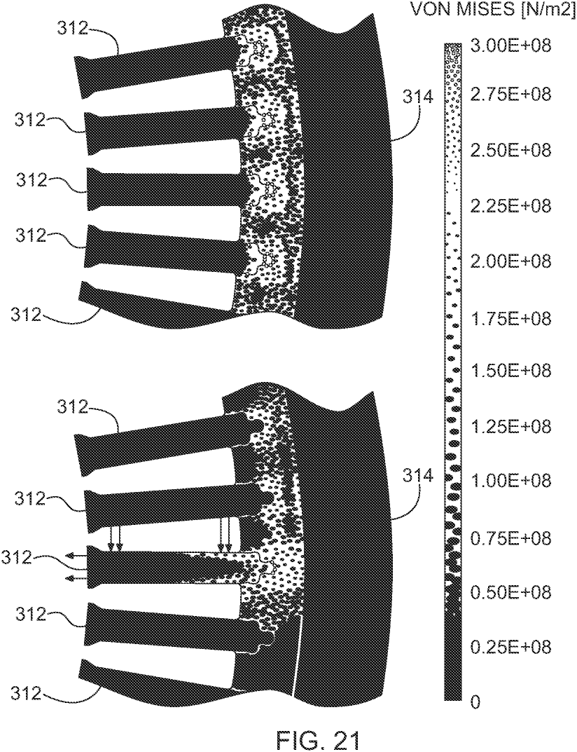

In another of its aspects the present invention may provide a multi-material (e.g., Hiperco®50+Silicon steel) stator core with teeth 312 and back-iron yoke 314 as shown in FIGS. 18-20. The fir-type connection has multiple stress points which provides a better mechanical strength in the mechanical joint because of the increased contact area between the teeth 312 and yoke 314. (The term “fir” is used, because the shape is suggestive of a fir tree.) Through our study, it is shown that an interference fit with 0.2 thou (0.0002″) interference (FIG. 20) leads to an acceptable stress at both passive and loaded condition in the stator stack, as illustrated in the simulation of FIG. 21.

### Pin Method for Multi-material Stack (Assembly Idea)

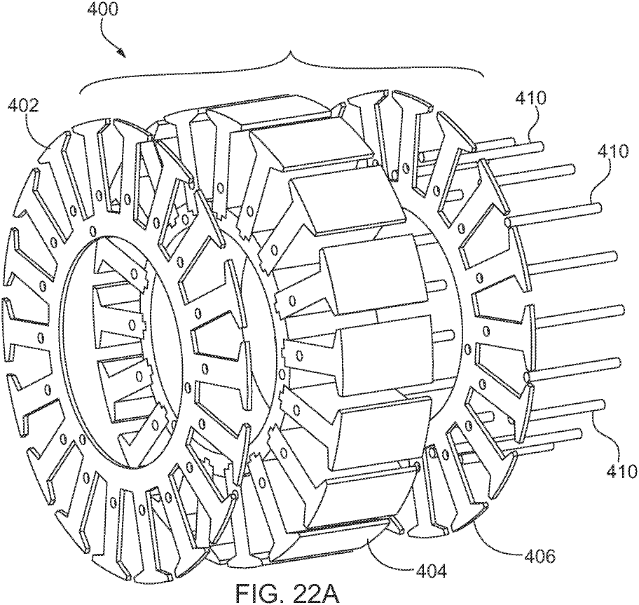

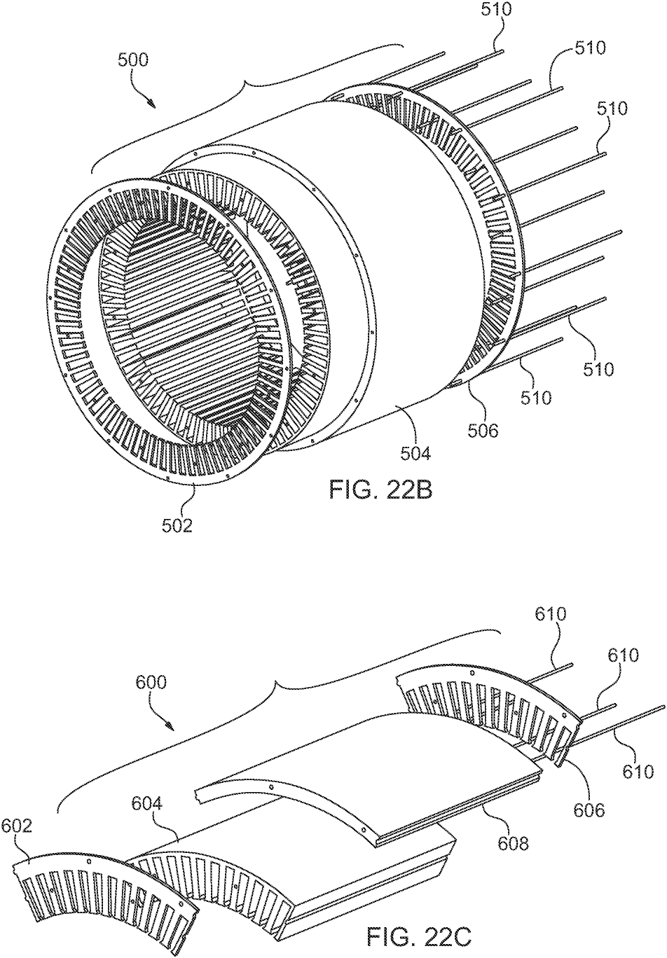

In yet another of its aspects the present invention may provide one or more pins to lock the stator laminations and hold the multi-materials stator stack together in place, FIGS. 22A-22C. Using pins in the mechanical joints may enable an adhesive-less interfacial joint between the Hiperco®50stack and silicon steel stack. This may help in improving large volume multi-materials stator production and as well, may improve the motor responses due to better interfacial magnetic responses.

Illustrations of exemplary core assemblies 400, 500, 600 with pins 410, 510, 610 are shown in FIGS. 22A-22C for a drone motor stator stack, EV motor stator stack, and segmented EV motor stator stack, respectively. Single-material lamination layers 402/406, 502/506, 602/606 may be used on two ends of the multi-material stack 400, 500, 600, respectively. This single material may high induction alloys or low induction alloys. Further, this single material may have better mechanical properties such as higher yield strength than the Hiperco®50 and Si steel material. Moreover, this single material may have similar lamination thickness as those used in the Hiperco®50 or Si steel stacks or can be 1.1 to 5 times thicker. The pins 410, 510, 610 may be used to lock the lamination layers 402/406, 502/506, 602/606. The various core assemblies 400, 500, 600 demonstrate that the pin method can be applied to motors with different sizes. A smaller pin diameter will introduce less impact on the stack performance.

Table 2 below shows our study on a small size (80 mm OD) core with multi-materials using low carbon steel pin connection with different sizes. The first column shows the ratio between pin diameter and stator tooth for each case. Through our study, a low carbon steel pin with diameter of ⅕ or less of the stator tooth width does not affect the stack performance significantly, and is cost-effective. Note that the ratio between pin diameter and tooth width can be smaller for large core, which is beneficial for the performance.

TABLE 2

| | Pout (W) | Total stator loss (W) | Pin loss (W) | Efficiency |
|---|---|---|---|---|
| No pin | 1457.7 | 32.3 | 0 | 90.8% |
| ⅓ ratio | 1394.9 | 64.2 | 31.3 | 88.8% |
| ⅕ ratio | 1429.4 | 39.9 | 6.3 | 90.4% |
| ⅛ ratio | 1435.7 | 35.7 | 2.5 | 90.5% |

FIG. 22C shows that pin method can also be used in segmented stack design for large motor 600 with a segmented yoke 608. The number and locations of pin holes may be determined by stack geometry and designer’s choice. Combination of assembly methods

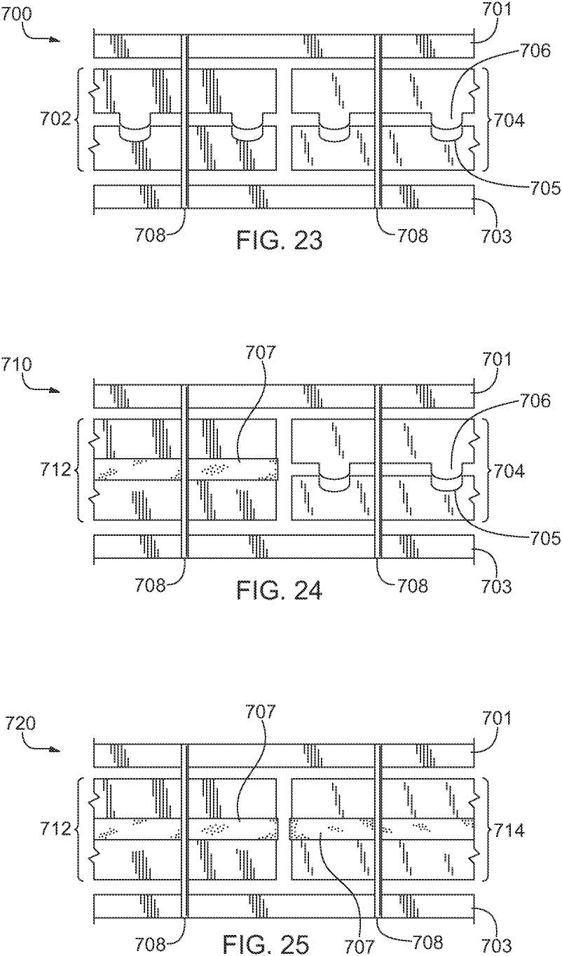

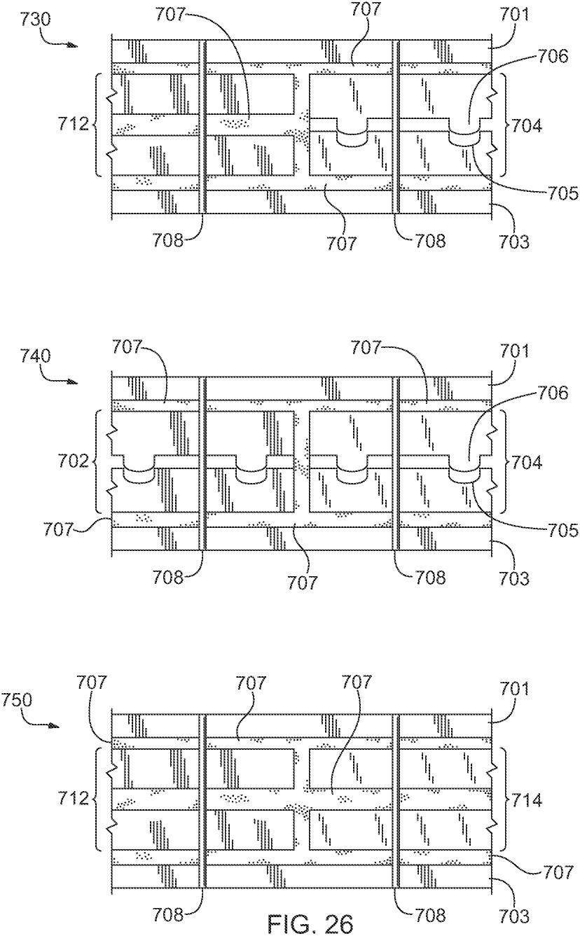

In another of its aspects the present invention may provide several combinations of stack assemblies 700, 710, 720, 730, 740, 750 and methods of assembly, FIGS. 23-26, Table 3. For example, a Hiperco® (FeCo) stack 702 and Si-steel stack 704 can be interlocked (FIG. 23), or both stacks 712, 714 can be bonded (FIG. 25), or some stacks can be interlocked 704 and the others bonded 712 (FIGS. 24, 26). The stack assemblies 700, 710, 720, 730, 740, 750 may include a Hiperco®50 top and bottom plates 701, 703 and pins 708 extending therethrough to hold the assemblies together, FIGS. 23-26.

The tooth segment laminations in the Hiperco® (FeCo) stack 702 can be heat treated and coated with an electrically insulation layer, for example, an oxide film if the stacks are uncoated prior to assembly. In addition of the pins, the interlocked the Hiperco® (FeCo) stack 702 and Si-steel stack 704 or the bonded 712 and 714 stacks can be assembled together using epoxy bonding technique. Bonding may be provided by an adhesive material 707, such as epoxy, which is then cured in the prescribed manner for the adhesive material. For example, curing some adhesives can be accomplished with heating a device to be cured in a heater or exposing the adhesive to a certain wavelength of light. As previously stated, Remisol EB-548 is an example of an adhesive for bonding stack laminations used in stators. The choice of adhesive and/or bonding material is based upon many factors, including at least its adhesion strength, thermal stability, water and chemical resistance, electrical insulation properties, magnetic properties, vibration control, and impact resistance.

Interlocking may be provided by tabs 706 and detents 705 for receiving the tabs 706, FIGS. 23, 24, 26. Interlocking may enable an adhesive-less stack and may reduce stack production cost significantly in mass scale. It may be possible to use a combination of the bonded and interlocked stack in combination with top and bottom plates 701, 703 along with the pins 708 to produce optimized stack solutions. Further, it might be possible to use one or multiple top and bottom plates 701, 703 and pins 708 to make the stack structure more robust.

Table 3 illustrates the possibilities of assembly methods combinations with reference to the figures listed therein.

TABLE 3

| | |
|---|---|
| FIG. 23 | FeCo— Si—steel stack, both interlocked,W top-bottom plate and pin. Applicable for FeCo lamination ≥ 0.15 mm (0.006″) |
| FIG. 24 | FeCo— Si—steel stack, one interlocked, other bonded w top-bottom plate and pin. Interlocking applicable for lamination ≥ 0.15 mm (0.006″) |
| FIG. 25 | FeCo— Si—steel stack, both bonded w top-bottom plate and pin. |
| FIG. 26 | FeCo— Si—steel stack, one interlocked, other bonded or both bonded or both interlocked, w top-bottom plate and pin. In addition adhesives may be used to bond single or multiple top and bottom plates to the rest of the structure. Interlocking applicable for lamination ≥ 0.15 mm (0.006″) |

These and other advantages of the present invention will be apparent to those skilled in the art from the foregoing specification. Accordingly, it will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

What is claimed is:

1. A stator assembly having a cylindrical shape with a longitudinal axis extending therethrough and a circular cross-section in a plane perpendicular to the longitudinal axis, the stator assembly comprising:
a plurality of tooth segments extending along a radial direction of the circular cross-section, the plurality of tooth segments each having a thickness, t, measured perpendicular to the radial direction and having a yoke-segment depth, d1, measured along the radial direction;
a plurality of yoke ring segments adjacent to and surrounding the tooth segments at the yoke-segment, the plurality of yoke ring segments having a depth, d, measured along the radial direction, the distance d including the yoke-segment depth, d1,
wherein a ratio of d to t is greater than 1:2.

2. The stator assembly of claim 1, wherein the tooth segments are formed of a soft magnetic alloy having a high saturation induction.

3. The stator assembly of claim 1, wherein the yoke ring segments are formed of a soft magnetic alloy having a lower saturation induction than the tooth segments.

4. The stator assembly of claim 1, wherein the ratio of d to t is between 1:2 and 2:1.

5. The stator assembly of claim 4, wherein the ratio of d1 to t is between 0 and 1:2.

6. The stator assembly of claim 4, wherein the ratio of d1 to t is between 1:2 and 2:1.

7. The stator assembly of claim 1, wherein the ratio of d to t is greater than 2:1.

8. The stator assembly of claim 7, wherein the ratio of d1 to t is between 0 and 1:4.

9. The stator assembly of claim 7, wherein the ratio of d1 to t is between 1:4 and 3:1.

10. The stator assembly of claim 1, wherein the ratio of d1 to t is between 0 and 1:2.

11. The stator assembly of claim 1, wherein the ratio of d1 to t is between 1:2 and 2:1.

12. The stator assembly of claim 1, wherein the ratio of d1 to t is between 0 and 1:4.

13. The stator assembly of claim 1, wherein the ratio of d1 to t is between 1:4 and 3:1.

14. The stator assembly of claim 1, wherein the plurality of tooth segments each comprise a plurality of stress points at a location of contact between a plurality of tooth segments and the plurality of yoke ring segments.

15. A stator assembly, comprising a plurality of tooth segments extending along a radial direction of the stator assembly, and a plurality of yoke ring segments adjacent to and surrounding the tooth segments, wherein the plurality of tooth segments each comprises a plurality of stress points at a location of contact between the tooth segments and the yoke ring segments.

16. A stator stack assembly for a rotating machine, comprising:
in order from a first end of the stack to an opposing second end, to provide the stack: a first end single-material lamination layer, a plurality of multi-material lamination layers, and a second end single-material lamination layer; and
a plurality of pins extending through the stack.

17. The stator stack assembly of claim 16, wherein the plurality of multi-material lamination layers includes a plurality of stator tooth segments and a plurality of stator yoke segments adjoining the stator tooth segments.

18. The stator stack assembly of claim 17, comprising an adhesive material to bond i) the plurality of multi-material lamination layers including the stator tooth segments together and/or ii) to bond the plurality of multi-material lamination layers including the stator yoke segments together.

19. The stator stack assembly of claim 16, comprising a tab in a selected first layer of the plurality of multi-material lamination layers and a complementary detent in a selected second layer of the plurality of multi-material lamination layers, the detent adjacent to and in registry with the at least one tab.

20. The stator stack assembly of claim 19, wherein the selected first layer includes the stator tooth segments.

21. The stator stack assembly of claim 19, wherein the selected first layer includes the stator yoke segments.

22. The stator stack assembly of claim 17, wherein the stator tooth segments are formed of a soft magnetic alloy having a high saturation induction.

23. The stator stack assembly of claim 17, wherein the stator yoke segments are formed of a soft magnetic alloy having a lower saturation induction than the stator tooth segments.

24. The stator stack assembly of claim 17, wherein the ratio of a diameter of the pin to a width, measure perpendicular to a radial direction, of a tooth of the stator tooth segments is preferably 1:3, more preferably 1:5, and most preferably 1:8.
